(19) United States
(12) Patent Application Publication
(10) Pub. No.: US 2026/0029279 A1
(43) Pub. Date: Jan. 29, 2026

(54) LASER PHASE NOISE MEASUREMENT DEVICE AND METHOD BASED ON OPTOELECTRONIC OSCILLATOR

(71) Applicant: INSTITUTE OF SEMICONDUCTORS, CHINESE ACADEMY OF SCIENCES, Beijing (CN)

(72) Inventors: Ming LI, Beijing (CN); Qizhuang CEN, Beijing (CN); Shanhong GUAN, Beijing (CN); Yitang DAI, Beijing (CN)

(73) Assignee: INSTITUTE OF SEMICONDUCTORS, CHINESE ACADEMY OF SCIENCESS, Beijing (CN)

(21) Appl. No.: 19/091,423

(22) Filed: Mar. 26, 2025

(30) Foreign Application Priority Data
Jul. 26, 2024 (NA) 202411017555.7

(51) Int. Cl. G01J 9/00

(52) U.S. Cl. CPC G01J 9/00

(57) ABSTRACT

The device includes: a laser to be measured used to output an optical carrier; a phase modulator used to modulate a microwave signal onto the optical carrier, to output a phase-modulated optical signal; an optical notch filter used to filter the phase-modulated optical signal, to output an intensity-modulated optical signal; a photodetector used to detect the intensity-modulated optical signal to output a radio frequency signal; a radio frequency power splitter used to split the radio frequency signal to output at least two radio frequency signals; and a radio frequency phase noise measurement system used to perform phase noise measurement on one of at least two radio frequency signals, to obtain the phase noise of the laser to be measured. One of at least two radio frequency signals is modulated onto the optical carrier by using the phase modulator to output phase-modulated optical signal.

### CROSS-REFERENCE TO RELATED APPLICATION

This application claims the priority of Chinese Patent Application No. 202411017555.7 filed on Jul. 26, 2024 in the China National Intellectual Property Administration, the content of which is incorporated herein by reference in entirety.

### TECHNICAL FIELD

The present disclosure relates to the field of optical communication, in particular to a laser phase noise measurement device and method based on an optoelectronic oscillator.

### BACKGROUND

The phase noise of a laser is important for evaluating the performance of the laser, which directly affects the application of lasers in communication, measurement, and signal processing fields. The phase noise of a laser is caused by various random processes inside the laser cavity, such as current noise, temperature fluctuations, optical feedback, etc. Accurately measuring the phase noise of the laser is crucial for optimizing laser design and improving system performance. The existing phase noise measurement techniques mainly include the following. Currently, the delay based self-heterodyne detection method is the most widely used, but its resolution and anti-interference ability are limited. The optical frequency comb reference method has the highest accuracy, but the cost is too high.

In response to the limitations in the prior art, the present disclosure proposes a novel laser phase noise measurement method and device, which achieves a high measurement sensitivity and a wide measurement bandwidth through the optoelectronic oscillator technology, thereby providing a powerful testing tool for optimizing the performance of the laser.

### SUMMARY

In view of the above issues, the present disclosure provides a laser phase noise measurement device and method based on an optoelectronic oscillator.

According to a first aspect of the present disclosure, a laser phase noise measurement device based on an optoelectronic oscillator is provided, including:
a laser to be measured configured to output an optical carrier;
a phase modulator configured to modulate a microwave signal onto the optical carrier, so as to output a phase-modulated optical signal;
an optical notch filter configured to filter the phase-modulated optical signal to output an intensity-modulated optical signal;
a photodetector configured to detect the intensity-modulated optical signal and output a radio frequency signal;
a radio frequency power splitter configured to split the radio frequency signal and output at least two radio frequency signals; and
a radio frequency phase noise measurement system configured to perform a phase noise measurement on one of the at least two radio frequency signals;
where the phase modulator is further configured to modulate the radio frequency signal as the microwave signal onto the optical carrier, so as to output the phase-modulated optical signal.

According to the embodiments of the present disclosure, the optical notch filter is any one of: a Fabry Perot cavity, an optical microcavity, an optical microdisk, an optical microsphere, a fiber ring, a grating, or a fiber grating.

According to the embodiments of the present disclosure, the optical notch filter includes an optical circulator and a Fabry Perot cavity, and the optical circulator includes a first port, a second port, and a third port; and
the phase modulator is connected to the first port, the Fabry Perot cavity is connected to the second port, and the photodetector is connected to the third port.

According to the embodiments of the present disclosure, the laser phase noise measurement device based on the optoelectronic oscillator further includes:
a radio frequency amplifier configured to amplify the radio frequency signal.

According to a second aspect of the present disclosure, a laser phase noise measurement method is provided, including:
outputting an optical carrier by using a laser to be measured.
modulating a microwave signal onto the optical carrier by using a phase modulator, so as to output a phase-modulated optical signal;
filtering the phase-modulated optical signal by using an optical notch filter to output an intensity-modulated optical signal;
detecting the intensity-modulated optical signal by using a photodetector to output a radio frequency signal;
splitting the radio frequency signal by using a radio frequency power splitter to output at least two radio frequency signals;
modulating one of the at least two radio frequency signals as the microwave signal onto the optical carrier by using the phase modulator, so as to output the phase-modulated optical signal; and
performing a phase noise measurement on one of the at least two radio frequency signals by using a radio frequency phase noise measurement system.

### BRIEF DESCRIPTION OF THE DRAWINGS

The above content, as well as other objectives, features, and advantages of the present disclosure, will become clearer through the following description of the embodiments of the present disclosure with reference to the accompanying drawings. In the accompanying drawings:

FIG. 1 shows a schematic diagram of a structure of a laser phase noise measurement device based on an optoelectronic oscillator according to an embodiment of the present disclosure;

FIG. 2A shows a schematic spectrum of a phase-modulated optical signal according to an embodiment of the present disclosure;

FIG. 2B shows a schematic spectrum of an intensity-modulated optical signal according to an embodiment of the present disclosure;

FIG. 2C shows a frequency spectrum of a radio frequency signal according to an embodiment of the present disclosure;

FIG. 3 shows a schematic diagram of a structure of another laser phase noise measurement device based on an optoelectronic oscillator according to an embodiment of the present disclosure;

FIG. 4 shows a schematic diagram of a structure of another laser phase noise measurement device based on an optoelectronic oscillator according to an embodiment of the present disclosure;

FIG. 5 shows the phase noise of a laser measured by the proposed laser phase noise measurement device based on an optoelectronic oscillator according to an embodiment of the present disclosure, and the phase noise of the same laser measured by a commercial laser phase noise measurement instrument OE4000; and

FIG. 6 shows a flowchart of a laser phase noise measurement method according to an embodiment of the present disclosure.

### DETAILED DESCRIPTION OF EMBODIMENTS

Hereinafter, the embodiments of the present disclosure will be described with reference to the drawings. However, it should be understood that these descriptions are only exemplary, and are not intended to limit the scope of the present disclosure. In the following detailed description, for ease of explanation, many specific details are set forth to provide a comprehensive understanding of the embodiments of the present disclosure. However, obviously, one or more embodiments may also be implemented without these specific details. In addition, in the following description, descriptions of well-known structures and technologies are omitted to avoid unnecessarily obscuring the concept of the present disclosure.

The terms used here are only for describing specific embodiments, and are not intended to limit the present disclosure. The terms “include”, “comprise”, etc. used herein indicate an existence of described characteristics, steps, operations and/or components, but do not exclude a presence or addition of one or more other characteristics, steps, operations or components.

Unless otherwise defined, all terms (including technical and scientific terms) used herein have the meanings commonly understood by those skilled in the art. It should be noted that the terms used here should be interpreted as having meanings consistent with the context of the specification, and should not be interpreted in an idealized or overly rigid manner.

In the case of using an expression similar to “at least one of A, B and C, etc.”, generally speaking, it should be interpreted according to the meaning of the expression commonly understood by those skilled in the art (for example, “a system having at least one of A, B, and C” shall include, but is not limited to, a system having A alone, B alone, C alone, A and B, A and C, B and C, and/or A, B and C, etc.).

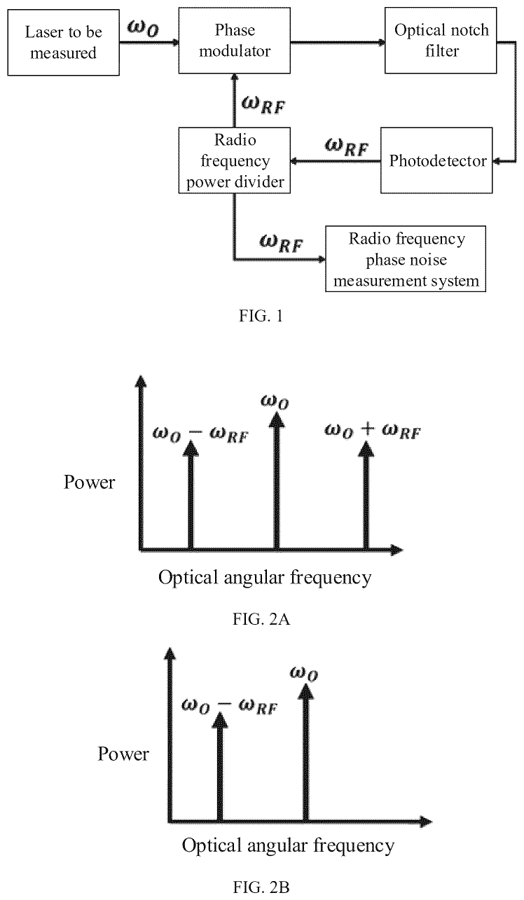

FIG. 1 shows a schematic diagram of a structure of a laser phase noise measurement device based on an optoelectronic oscillator according to an embodiment of the present disclosure.

As shown in FIG. 1, the laser phase noise measurement device based on the optoelectronic oscillator in this embodiment includes a laser to be measured, a phase modulator, an optical notch filter, a photodetector, a radio frequency power splitter, and a radio frequency phase noise measurement system. The laser to be measured is used to output an optical carrier. The phase modulator is used to modulate a microwave signal onto the optical carrier, so as to output a phase-modulated optical signal. The optical notch filter is used to filter the phase-modulated optical signal to output an intensity-modulated optical signal. The photodetector is used to detect the intensity-modulated optical signal to output a radio frequency signal. The radio frequency power splitter is used to split the radio frequency signal to output at least two radio frequency signals. The radio frequency phase noise measurement system is used to perform a phase noise measurement on one of the at least two radio frequency signals. The phase noise of the laser can be obtained from the measured results of the radio frequency. The phase modulator is further used to modulate the radio frequency signal as the microwave signal onto the optical carrier, so as to output the phase-modulated optical signal.

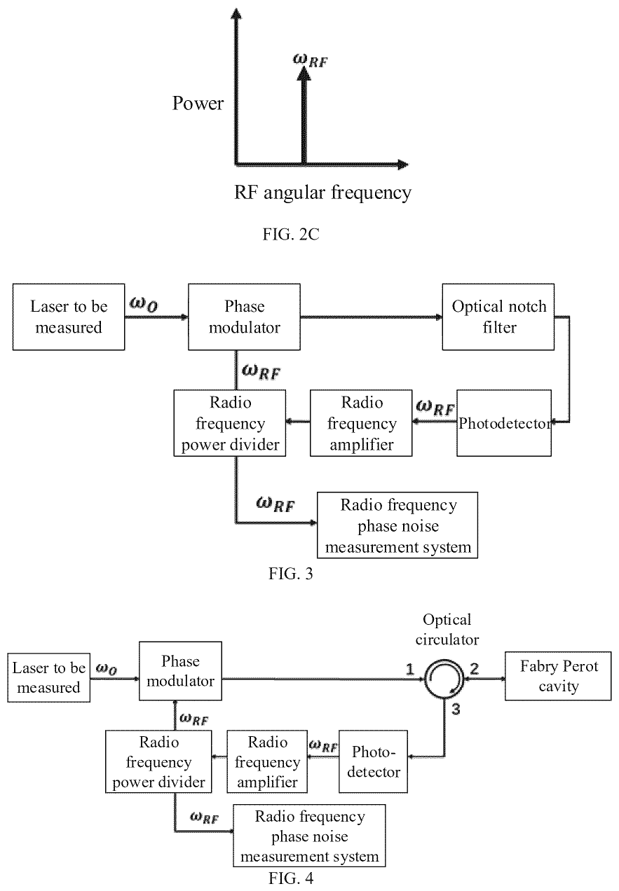

According to an embodiment of the present disclosure, a laser phase noise measurement device based on phase-modulated-to-intensity-modulated optoelectronic oscillator is constructed. The center angular frequency of the laser to be measured is ω₀, and a center angular frequency of the optical notch filter is ω_{N}. Without loss of generality, assume that ω_{N}>ω₀. When the gain of the optoelectronic link is large enough, a radio frequency signal with an angular frequency of ω_{RF}=ω_{N}−ω₀ will spontaneously be generated. The radio frequency signal is modulated onto the optical carrier through the phase modulator. Ignoring higher-order sidebands, the spectrum of the phase-modulated optical signal output after the phase modulator is shown in FIG. 2A. The phase-modulated optical signal is input into the optical notch filter. The spectrum of the intensity-modulated optical signal output after the optical notch filter is shown in FIG. 2B. The intensity-modulated optical signal output by the optical notch filter is detected by the photodetector to obtain the radio frequency signal with the angular frequency of ω_{RF}. The frequency spectrum of the radio frequency signal output after the photodetector is shown in FIG. 2C. When the frequency of the laser changes, the oscillating frequency of the optoelectronic oscillator also changes, thereby achieving the transfer of phase/frequency fluctuations of the laser to the radio frequency signal generated by the optoelectronic oscillator.

FIG. 3 shows a schematic diagram of a structure of another laser phase noise measurement device based on an optoelectronic oscillator according to an embodiment of the present disclosure.

As shown in FIG. 3, in addition to the laser to be measured, the phase modulator, the optical notch filter, the photodetector, and the radio frequency power splitter shown in FIG. 1, the laser phase noise measurement device based on the optoelectronic oscillator provided in this embodiment further includes a radio frequency amplifier used to amplify the radio frequency signal.

FIG. 4 shows a schematic diagram of a structure of another laser phase noise measurement device based on an optoelectronic oscillator according to an embodiment of the present disclosure.

As shown in FIG. 4, the laser phase noise measurement device based on the optoelectronic oscillator provided in this embodiment includes a laser to be measured, a phase modulator, an optical notch filter, a photodetector, a radio frequency amplifier, a radio frequency power splitter, and a radio frequency phase noise measurement system. The optical notch filter includes an optical circulator and a Fabry Perot cavity. The optical circulator includes a first port, a second port, and a third port. The phase modulator is connected to the first port 1, the Fabry Perot cavity is connected to the second port 2, and the photodetector is connected to the third port 3.

According to an embodiment of the present disclosure, the Fabry Perot cavity is used as the optical notch filter. The modulated optical signal enters the optical circulator through the first port 1 and is output to the Fabry Perot cavity through the second port 2. The light reflected by the cavity is output through the third port 3 of the optical circulator. In this structure, the output signal at the third port 3 of the optical circulator is the signal output through Fabry Perot cavity notch filtering. The optical signal is detected by the photodetector, amplified by the radio frequency amplifier, and divided by the radio frequency power splitter for output. The radio frequency phase noise measurement system is used to measure the phase noise of one of the radio frequency signals after the radio frequency power splitter.

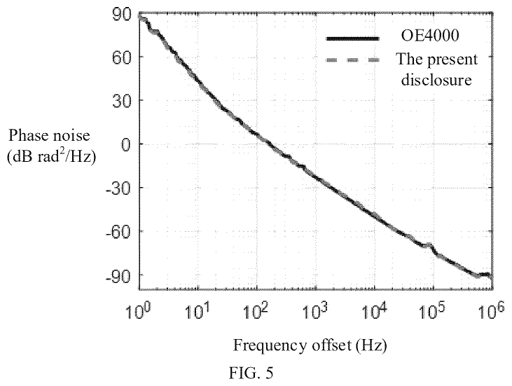

According to an embodiment of the present disclosure, FIG. 5 shows the phase noise of a laser measured by the laser phase noise measurement device provided in this embodiment, and the phase noise of the laser measured by the commercial laser phase noise measurement instrument OE4000. It may be seen that the phase noise of the oscillating radio frequency signal is almost identical to that of the laser to be measured, indicating that the device accurately measured the laser phase noise.

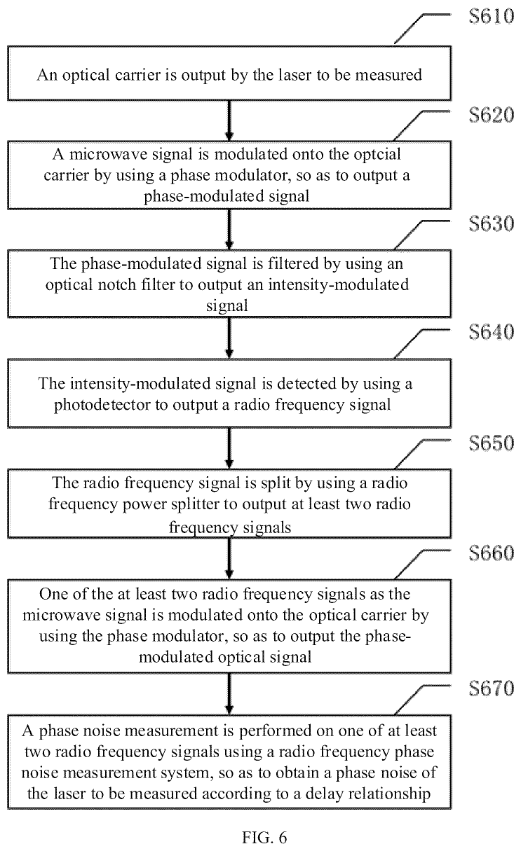

FIG. 6 shows a flowchart of a laser phase noise measurement method according to an embodiment of the present disclosure.

As shown in FIG. 6, the laser phase noise measurement method in this embodiment includes operations S610 to S670.

In operation S610, an optical carrier is output by the laser to be measured.

In operation S620, a microwave signal is modulated onto the optical carrier by using a phase modulator, so as to output a phase-modulated optical signal.

In operation S630, the phase-modulated optical signal is filtered by using an optical notch filter to output an intensity-modulated optical signal.

In operation S640, the intensity-modulated optical signal is detected by using a photodetector to output a radio frequency signal.

In operation S650, the radio frequency signal is split by using a radio frequency power splitter to output at least two radio frequency signals.

In operation S660, one of the at least two radio frequency signals as the microwave signal is modulated onto the optical carrier by using the phase modulator, so as to output the phase-modulated optical signal.

In operation S670, a phase noise measurement is performed on one of the at least two radio frequency signals using a radio frequency phase noise measurement system.

The delay of the optical notch filter at resonance is set to τ₀, the delay of the optoelectronic link excluding the optical notch filter is set to τ_{RF}, and the phase noise of the laser to be measured is set to S₀(f). Therefore, the phase noise of the radio frequency signal generated by optoelectronic oscillator, denoted as S_{RF}(f), is:

$${S}_{RF} ( f ) = {( \frac{{τ}_{O}}{{τ}_{RF} + {τ}_{O}} )}^{2} {S}_{O} ( f ) \qquad ( 1 )$$

From equation (1), it may be seen that the phase noise of the laser to be measured is allocated to the radio frequency signal generated by optoelectronic oscillator. By measuring the phase noise of the radio frequency signal, the phase noise of the laser to be measured may be obtained using the equation (1).

Furthermore, in the embodiments of the present disclosure, by reducing the delay τ_{RF} of the radio frequency signal and increasing the delay τ₀ of the optical notch filter (which may be achieved by using a filter with a narrower bandwidth), it is possible to make τ₀ »τ_{RF}, resulting in

$${( \frac{{τ}_{O}}{{τ}_{RF} + {τ}_{O}} )}^{2} \approx 1 .$$

That is, the oscillating radio frequency signal almost completely replicates the phase noise of the laser to be measured. Therefore, in some implementations, the phase noise of the laser to be measured may be obtained by directly measuring the phase noise of the radio frequency signal.

The delay τ₀ of the optical notch filter is much greater than the delay τ_{RF} of the radio frequency signal, which may be set reasonably according to different scenarios and application requirements. The delay τ₀ of the optical notch filter may be 100 times, 500 times, 1000 times, etc. of the delay τ_{RF} of the radio frequency signal.

The laser phase noise measurement device and method based on the optoelectronic oscillator provided in the embodiments of the present disclosure have at least the following technical effects:
(1) Compared with other laser measurement schemes, the scheme in the present disclosure is less susceptible to external environmental disturbances and may obtain lower system noise;
(2) Compared with other laser measurement schemes, the structure in the present disclosure is simpler, does not require long optical fibers, and may be integrated/miniaturized;
(3) Compared with the heterodyne beat frequency scheme based on fiber optic delay lines, the frequency range measured in the present disclosure is much wider;
(4) Compared with the phase noise measurement scheme based on a reference laser, the present disclosure does not require the use of any reference laser.
(5) The laser phase noise measurement in the present disclosure may be used in discrete device systems or integrated optoelectronic systems, and may be implemented based on different types of optical filters.

The flowcharts and block diagrams in the accompanying drawings illustrate the possible architectures, functions, and operations implemented by the system and the method according to various embodiments of the present disclosure. In this regard, each box in the flowchart or the block diagram may represent a module, a program segment, or a part of code that contains one or more executable instructions for implementing specified logical functions. It should also be noted that in some alternative implementations, the functions marked in the boxes may be executed in a different order than those marked in the accompanying drawings. For example, two consecutive boxes may actually be executed in parallel, and sometimes they may also be executed in a reverse order, depending on the functions involved. It should also be noted that each box in the block diagram or the flowchart, as well as combinations of boxes in the block diagram or the flowchart, may be implemented using dedicated hardware-based systems that perform specified functions or operations, or may be implemented using a combination of dedicated hardware and computer instructions.

Those skilled in the art may understand that the features described in the various embodiments of the present disclosure and/or the claims may be combined and/or incorporated in various ways, even if such combinations or incorporations are not explicitly described in the present disclosure. In particular, without departing from the spirit and teachings of the present disclosure, the various embodiments of the present disclosure and/or the features described in the claims may be combined and/or incorporated in various ways. All these combinations and/or incorporations fall within the scope of the present disclosure.

The embodiments of the present disclosure have been described above. However, these embodiments are for illustrative purposes only, and are not intended to limit the scope of the present disclosure. Although the respective embodiments are described above, this does not mean that the measures in the respective embodiments may not be advantageously used in combination. The scope of the present disclosure is defined by the appended claims and their equivalents. Those skilled in the art may make various substitutions and modifications without departing from the scope of the present disclosure, and these substitutions and modifications should all fall within the scope of the present disclosure.

What is claimed is:

1. A laser phase noise measurement device based on an optoelectronic oscillator, comprising:
a laser to be measured configured to output an optical carrier;
a phase modulator configured to modulate a microwave signal onto the optical carrier, so as to output a phase-modulated optical signal;
an optical notch filter configured to filter the phase-modulated optical signal to output an intensity-modulated optical signal;
a photodetector configured to detect the intensity-modulated optical signal to output a radio frequency signal;
a radio frequency power splitter configured to split the radio frequency signal to output at least two radio frequency signals; and
a radio frequency phase noise measurement system configured to perform a phase noise measurement on one of the at least two radio frequency signals;
wherein the phase modulator is further configured to modulate the radio frequency signal as the microwave signal onto the optical carrier, so as to output the phase-modulated optical signal.

2. The laser phase noise measurement device based on the optoelectronic oscillator according to claim 1, wherein the optical notch filter is any one of: a Fabry Perot cavity, an optical microcavity, an optical microdisk, an optical microsphere, a fiber ring, a grating, or a fiber grating.

3. The laser phase noise measurement device based on the optoelectronic oscillator according to claim 1, further comprising:
a radio frequency amplifier configured to amplify the radio frequency signal.

4. A laser phase noise measurement method, comprising:
outputting an optical carrier by using a laser to be measured;
modulating a microwave signal onto the optical carrier by using a phase modulator, so as to output a phase-modulated optical signal;
filtering the phase-modulated optical signal by using an optical notch filter to output an intensity-modulated optical signal;
detecting the intensity-modulated optical signal by using a photodetector to output a radio frequency signal;
splitting the radio frequency signal by using a radio frequency power splitter to output at least two radio frequency signals;
modulating one of the at least two radio frequency signals as the microwave signal onto the optical carrier by using the phase modulator, so as to output the phase-modulated optical signal; and
performing a phase noise measurement on one of the at least two radio frequency signals by using a radio frequency phase noise measurement system.
